(19) United States
(12) Patent Application Publication
(10) Pub. No.: US 2023/0150676 A1
(43) Pub. Date: May 18, 2023

(54) DROGUE PARACHUTE SYSTEM FOR SPACECRAFT

(71) Applicant: AT SPACE PTY LTD, North Adelaide (AU)

(72) Inventor: Yen-Sen CHEN, North Adelaide (AU)

(21) Appl. No.: 18/097,208

(22) Filed: Jan. 14, 2023

Related U.S. Application Data
(63) Continuation-in-part of application No. 17/355,176, filed on Jun. 23, 2021.

(51) Int. Cl. B64D 17/80; B64D 17/22

(52) U.S. Cl. CPC B64D 17/80; B64D 17/22

(57) ABSTRACT

A drogue parachute system for a spacecraft includes a first parachute that is inflatable, at least one inflating device that is connected to the first parachute and can inflate the first parachute, a first set of connection lines, an extension device, a second set of connection lines, a second parachute and a third set of connection lines. Each connection line of the first set of connection lines includes two opposite ends respectively connected to the first parachute and the spacecraft. Each connection line of the second set of connection lines includes two opposite ends respectively connected to the extension device and the first parachute. Each connection line of the third set of connection lines includes two opposite ends respectively connected to the second parachute and the extension device. The first parachute fully deployed is reverse umbrella-shaped with respect to the spacecraft.

### CROSS-REFERENCE TO RELATED APPLICATIONS

This application is a continuation-in-part of U.S. Pat. application Ser. No. 17/355,176 filed on Jun. 23, 2021. The above application is incorporated by reference herein.

### BACKGROUND

### Field of the Invention

The present invention relates to a spacecraft recovery technology, and more particularly to a drogue parachute system for a spacecraft.

### Description of Related Art

Conventional launch vehicles are designed to have their upper stage reenter the Earth atmosphere after launch vehicles deliver satellite payload into orbit. The upper stage is then burned away through the reentry flight because hypersonic flight speed and increasing air density led to extremely high heating rates. For spacecraft reentry and recovery operations for crew or payload return to Earth safely, heat shields designed to handle the aerothermodynamic effects are employed to pass through the reentry flight high-heating phase without damaging the payload and/or putting the crew at risk. Spacecraft and upper stage recovery technology present high added value to the overall space launch system.

### SUMMARY

One objective of the present invention is to provide a drogue parachute system for a spacecraft, and the drogue parachute system is capable of preventing the spacecraft from experiencing the aerothermal heat impact in the reentry flight of the spacecraft to the Earth so that a safe and stable reentry flight is possibly achieved for spacecraft recovery.

Another objective of the present invention is to provide a drogue parachute system for a spacecraft, and the drogue parachute system is capable of inducing a safe and stable reentry flight by slowing down the spacecraft during the reentry flight.

To achieve the foregoing or other objectives, the present invention provides a drogue parachute system for a spacecraft according to an embodiment, and the drogue parachute system includes a first parachute, a first set of connection lines, an extension device, a second set of connection lines that is inflatable, at least one inflating device that is connected to the first parachute and configured to inflate the first parachute, a second parachute and a third set of connection lines. Each connection line of the first set of connection lines includes two opposite ends respectively connected to the first parachute and the spacecraft. Each connection line of the second set of connection lines includes two opposite ends respectively connected to the extension device and the first parachute. Each connection line of the third set of connection lines includes two opposite ends respectively connected to the second parachute and the extension device. The first parachute fully deployed is reverse umbrella-shaped with respect to the spacecraft.

Optionally, a distance between a periphery of the first parachute in operation and the spacecraft is longer than a distance between a center of the first parachute in operation and the spacecraft.

Optionally, a distance between a periphery of the second parachute in operation and the spacecraft is shorter than a distance between a center of the second parachute in operation and the spacecraft.

Optionally, the extension device comprises an inner space for accommodating the second parachute and the third set of connection lines.

Optionally, the drogue parachute system further includes a housing for accommodating the first parachute, the first set of connection lines, the second set of connection lines, the extension device, the second parachute and the third set of connection lines.

Optionally, the second parachute and the third set of connection lines are released from the extension device after the extension device is pushed out from the spacecraft, and then the second set of connection lines, the first parachute and the first set of connection lines are released from the spacecraft.

Optionally, at least a part of the extension device is flexible.

Optionally, the first, second and third sets of connection lines are made of at least a bulletproof material.

Optionally, the second parachute is smaller than the first parachute.

Optionally, connection lines of the first set of connection lines connected to a central portion of the first parachute are shorter than connection lines of the first set of connection lines connected to a periphery portion of the first parachute.

Optionally, a central portion of the first parachute is thicker than a periphery portion of the first parachute when the first parachute is fully deployed.

Optionally, the second set of connection lines, the first parachute and the first set of connection lines are pulled out from the spacecraft by a drag force of the second parachute after the second parachute is deployed.

Optionally, the second set of connection lines, the extension device, the third set of connection lines and the second parachute are lay idle after the first parachute is fully deployed.

Optionally, the first parachute comprises a first surface and a second surface opposite to the first surface, one of the first and second surfaces is disposed with at least one pressure regulator connected to the at least one inflating device, and the at least one inflating device inflates the first parachute with compressed gas stored in the inflating device, through the at least one pressure regulator.

Optionally, the first parachute comprises at least one gas chamber for being inflated by the compressed gas.

Optionally, an amount of gas chambers in the first parachute is plural, and every two adjacent ones of the gas chambers are connected to each other and have vents on a connection therebetween.

Optionally, the first parachute comprises a first surface and a second surface opposite to the first surface, a part of the first set of connection lines is connected to the first surface in a central portion of the first parachute, another part of the first set of connection lines is connected to the first surface in a periphery portion of the first parachute, and the second set of connection lines is connected to the second surface in the central portion of the first parachute.

### BRIEF DESCRIPTION OF THE DRAWINGS

After studying the detailed description in conjunction with the following drawings, other aspects and advantages of the present invention will be discovered:

FIGS. 1 to 4 are schematic diagrams illustrating steps of the process of releasing a drogue parachute system for a spacecraft according to an embodiment of the present invention;

FIG. 5 is a schematic diagram illustrating a part of the drogue parachute system fully released from the spacecraft, at a view point according to an embodiment of the present invention, to mainly show the full deployment of the first parachute;

FIG. 6 is a schematic diagram illustrating a part of the drogue parachute system fully released from the spacecraft, at another view point according to an embodiment of the present invention, to mainly show the full deployment of the first parachute;

FIG. 7 is a side view of a part of the drogue parachute system fully released from the spacecraft according to an embodiment of the present invention, to mainly show the full deployment of the first parachute; and

FIG. 8 is a cross-section view of a part of the drogue parachute system of FIG. 7 according to an embodiment of the present invention.

### DETAILED DESCRIPTION

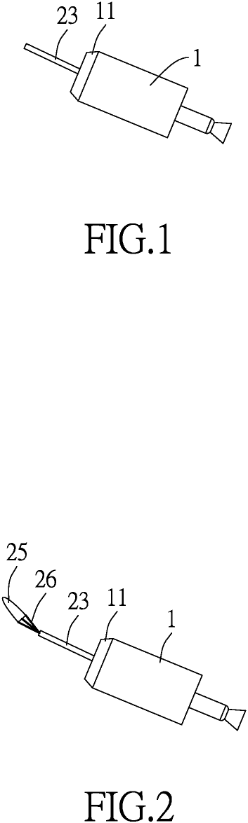

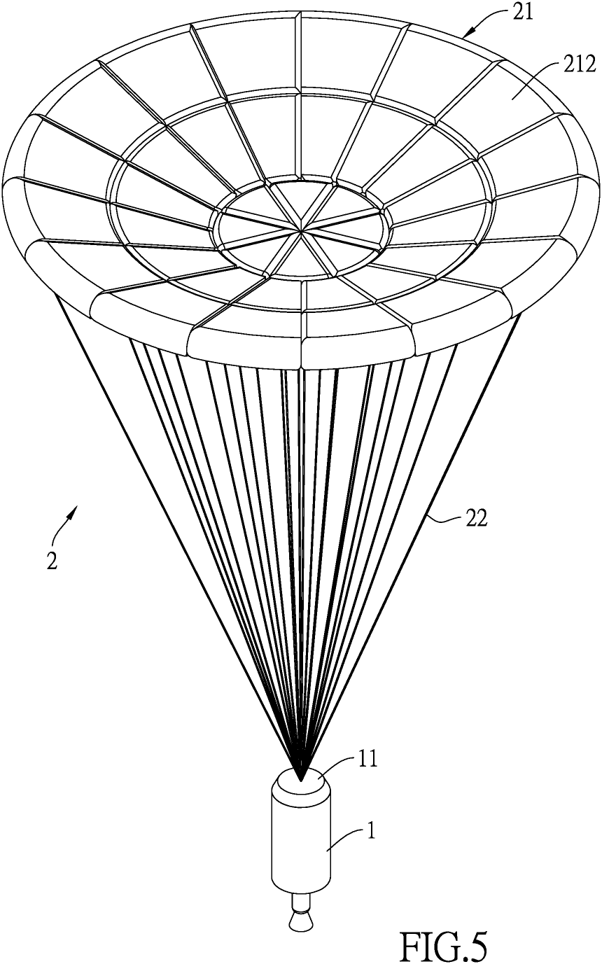

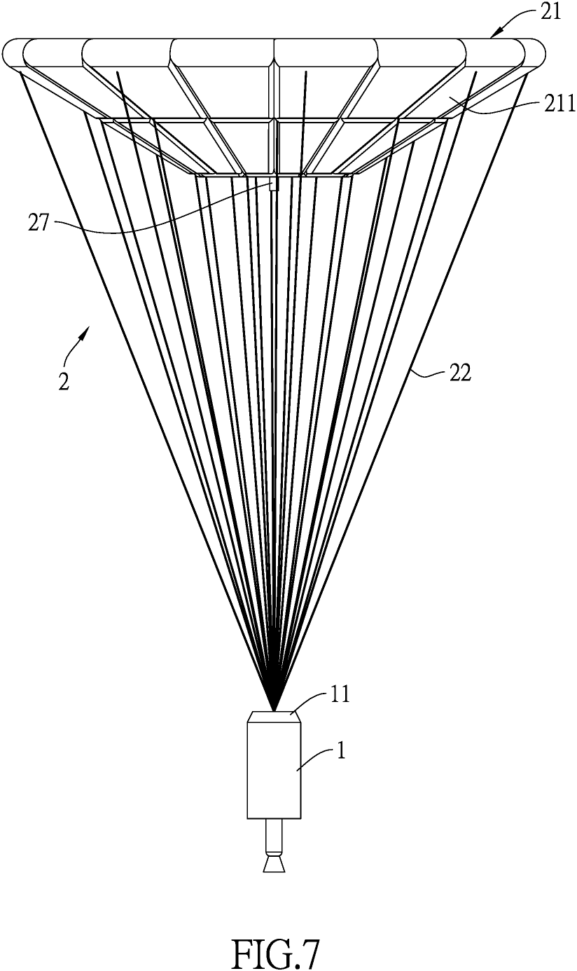

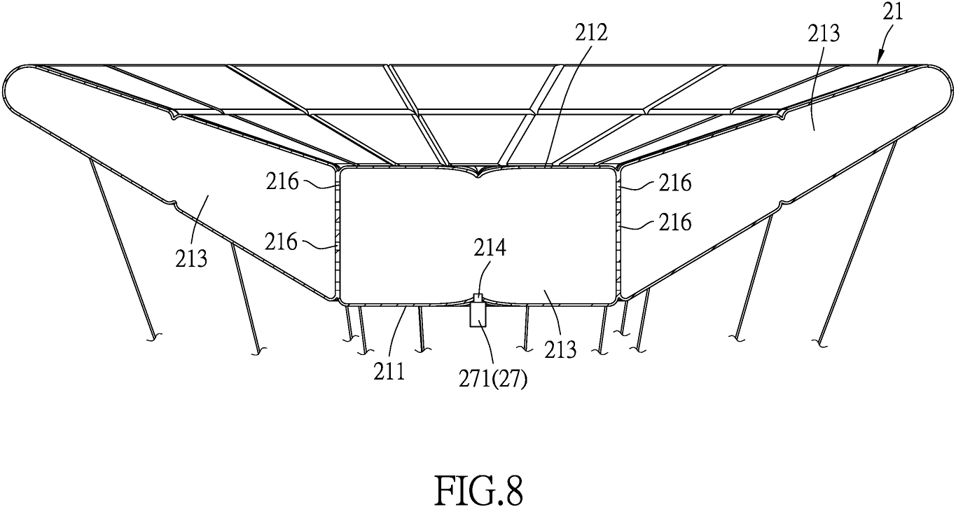

Please refer to FIGS. 1 to 8, illustrating a drogue parachute system 2 and the process of releasing the drogue parachute system 2 from a payload 11 of a spacecraft 1 according to an embodiment of the present invention. The drogue parachute system 2 is suitable to be disposed to the spacecraft 1. The drogue parachute system 2 includes a housing (not shown), a circuit board with a timer (not shown), a first parachute 21, a first set of connection lines 22, an extension device 23, a second set of connection lines 24, a second parachute 25, a third set of connection lines 26, and an inflating device 27.

The housing has an inner space for accommodating the circuit board, the first parachute 21, the first set of connection lines 22, the extension device 23, the second set of connection lines 24, the second parachute 25 and the third set of connection lines 26, and is contained in the payload 11 of the spacecraft 1, for example. The circuit board is communicable with an avionics system of the spacecraft 1, so as to program a parashell deployment signal according to the altitude data provided by the avionics system, and trigger an inflation sequence of the drogue parachute system 2 according to the parashell deployment signal.

The first parachute 21 is an inflatable parachute contained in a fabric container stored in the housing. The central portion of the first parachute 21 is, for example but not limited to, thicker than the periphery portion of the first parachute 21 when the first parachute 21 is fully inflated, so that the cross-section shape of the first parachute 21 fully inflated is approximately a crescent moon shape. This is conducive to preventing the fully-inflated first parachute 21 from deformation during the reentry flight of the spacecraft 1 to the Earth.

The first parachute 21 includes a first surface 211, a second surface 212 opposite to the first surface 211, and includes, for example but not limited to, gas chambers 213 therein, and a pressure regulator 214 mounted on the first surface 211 in the central portion of the first parachute 21 at the center and connected to the inflating device 27. Every two adjacent gas chambers 213 are connected to each other and have vents 216 on the connection therebetween, so all the gas chambers 213 are communicable with each other. The pressure regulator 214 has an air channel therein for gas inflation and deflation, and the air channel is operationally communicable with the gas chambers 213, so the pressure regulator 214 can control the pressure level of the first parachute 21.

The inflating device 27 has a compact size, is lightweight, and includes a gas storage 271 (ex., one or more gas bottles) for storing compressed gas, and is communicable with the circuit board. The gas storage 271 is affixed to the first surface 211 in the central portion of the first parachute 21 at the center by a fixture made of a bulletproof material, such as KEVLAR fiber, is connected to the pressure regulator 214 and operationally communicable with the air channel of the pressure regulator 214, and is triggerable by the circuit board according to the inflation sequence to inflate the gas chambers 213 with the compressed gas stored therein, through the pressure regulator 214. The pressure regulator 214 automatically stops the flow of the compressed gas from the gas storage 271 into the gas chambers 213 when the pressure level of the first parachute 21 achieves a desired value that all the gas chambers 213 are fully inflated.

Each connection line of the first set of connection lines 22 includes two opposite ends respectively connected to the payload 11 and the first parachute 21. Some connection lines 22 of the first set of connection lines 22 are connected to the first surface 211 in the central portion of the first parachute 21, and some connection lines 22 of the first set of connection lines 22 are connected to the first surface 211 in the periphery portion of the first parachute 21. The connection lines 22 connected to the central portion of the first parachute 21 are shorter than the connection lines 22 connected to the periphery portion of the first parachute 21. Each connection line of the second set of connection lines 24 includes two opposite ends respectively connected to the first parachute 21 and the extension device 23. The second set of connection lines 24 is connected to the second surface 212 in the central portion of the first parachute 21. Each connection line of the third set of connection lines 26 includes two opposite ends respectively connected to the extension device 23 and the second parachute 25. The first, second and third sets of connection lines are made of at least a bulletproof material, such as KEVLAR fiber.

At least a part of the extension device 23 is flexible and is a lightweight passive extension teleport so that it is easy to receive the extension device 23 into the housing. The extension device 23 is tube-shaped and includes an inner space (not shown) for accommodating the second parachute 25 and the third set of connection lines 26.

The second parachute 25 is, for example but not limited to, a drogue chute, and is smaller than the first parachute 21 when they are fully inflated and deployed. The second parachute 25 is spring-loaded and contained in the extension device 23, and can be pushed out from the extension device 23 when the spring releases according to the control of the circuit board, thereby functioning to pull out the first parachute 21 from the fabric container of the first parachute 21.

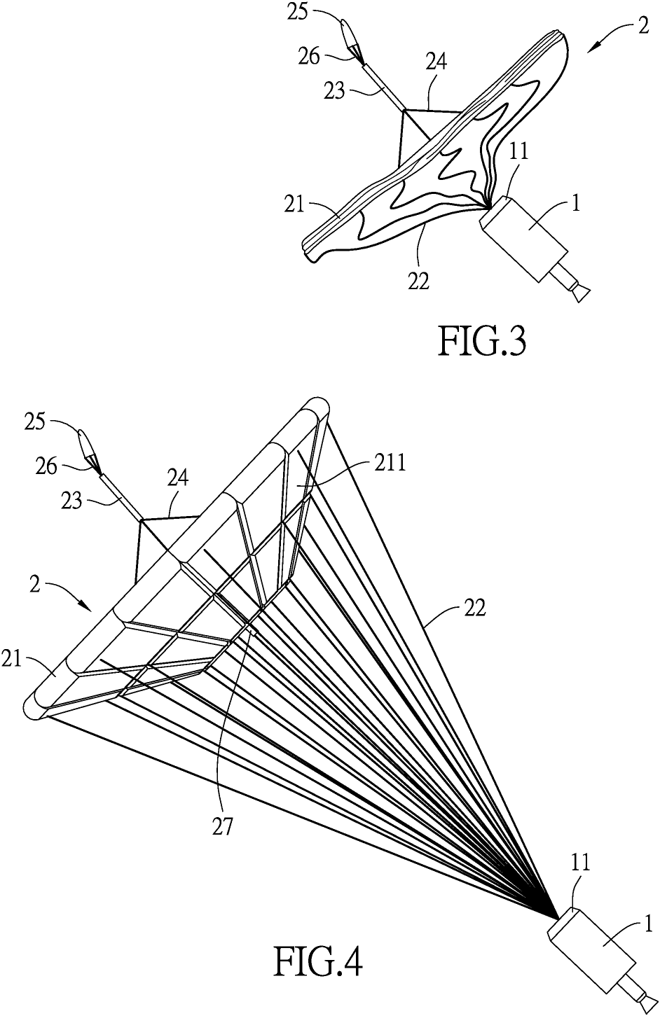

In the inflation sequence, the drogue parachute system 2 except the housing is released from the payload 11 by the following steps: (1) pushing out the extension device 23 from the housing contained in the payload 11 before the spacecraft 1 enters its reentry flight that can be initiated by the deorbiting maneuver of the spacecraft 1, as shown in FIG. 1; (2) pushing out the second parachute 25 and the third set of connection lines 26 from the extension device 23 before the spacecraft 1 enters its reentry flight and after the extension device 23 is pushed out; (3) inflating the second parachute 25 in the beginning of the reentry flight of the spacecraft 1, as shown in FIG. 2; (4) pulling out the first parachute 21, the first set of connection lines 22 and the second set of connection lines 24 from the housing by the drag force of the fully-deployed second parachute 25, as shown in FIG. 3; and (5) inflating the first parachute 21 with the compressed gas stored in the inflating device 27 after the first parachute 21 and the second set of connection lines 24 are pulled out, as shown in FIG. 4. The extension device 23, the second set of connection lines 24, the second parachute 25 and the third set of connection lines 26 are lay idle after the second parachute 25 and the third set of connection lines 26 are pulled out.

In the process of releasing the drogue parachute system 2 except the housing, the releasing of the extension device 23 is prior to the releasing of the second parachute 25 so that the third set of connection lines 26 is possibly prevented from fouling each other and entangling with the spacecraft 1. In the opening state of the second parachute 25, a distance between a periphery of the second parachute 25 and the spacecraft 1 is shorter than a distance between a center of the second parachute 25 and the spacecraft 1.

When the first parachute 21 is fully inflated and deployed, the first parachute 21 possibly maintains its reverse umbrella shape with respect to the spacecraft 1 during the descending of the spacecraft 1 since in addition to the crescent-moon shaped cross section of the first parachute 21, the compressed gas within the gas chambers 213 makes the first parachute 21 maintain fully spread out and the first set of connection lines 22 pulls on the first parachute 21. In the opening state of the first parachute 21, a distance between a periphery of the first parachute 21 and the spacecraft 1 is longer than a distance between a center of the first parachute 21 and the spacecraft 1. Through the opened first parachute 21 as an aeroshell, the spacecraft 1 is possibly slowed down gradually when passing through the thin-air region of the reentry flight. When the spacecraft 1 reaches the denser part of the atmosphere, the flight speed of the spacecraft 1 has already become low enough. In this way, there would be no aerothermal heating imposed on the spacecraft 1 throughout the reentry flight, and the spacecraft 1 possibly returns to the earth surface safely.

Although the forgoing embodiment is exemplarily described based on a case of the housing disposed in the payload 11, the present invention is not limited to this example. In other embodiments, the housing containing the first parachute 21, the first set of connection lines 22, the extension device 23, the second set of connection lines 24, the second parachute 25 and the third set of connection lines 26 may be disposed in another part of the spacecraft 1 instead of the payload 11.

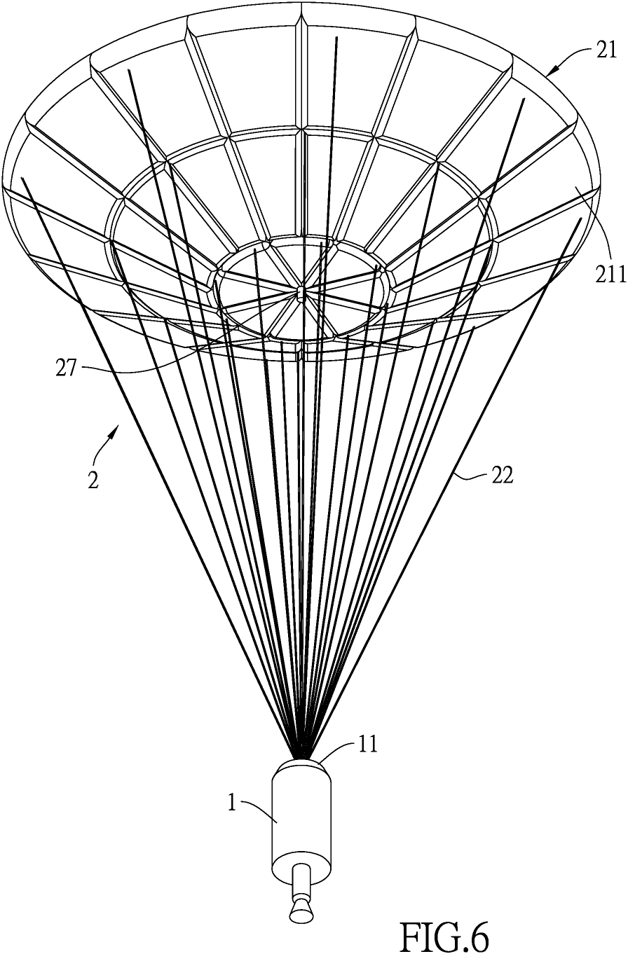

Although there are more than one gas chambers 213 in the first parachute 21, the present invention is not limited to this example; and in other embodiments, the first parachute 21 can be modified to have only one gas chamber 213 therein. Likewise, although one inflating device 27 is utilized to inflate more than one gas chambers 213 of the first parachute 21, the present invention is not limited to this example; and in other embodiments, the drogue parachute system 2 can be modified to have more inflating devices 27 for inflating the gas chambers 213. Similarly, the pressure regulator 214 and the inflating device 27 are disposed to the first surface 211 as shown in FIGS. 6 to 8, the present invention is not limited to this example; and in other embodiments, it may be contemplated that the pressure regulator 214 and the inflating device 27 are disposed to the second surface 212.

While we have shown and described various embodiments in accordance with the present invention, it is clear to those skilled in the art that further embodiments may be made without departing from the scope of the present invention.

What is claimed is:

1. A drogue parachute system for a spacecraft, comprising:
a first parachute, being inflatable;
at least one inflating device, connected to the first parachute and configured to inflate the first parachute;
a first set of connection lines, each comprising two opposite ends respectively connected to the first parachute and the spacecraft;
an extension device;
a second set of connection lines, each comprising two opposite ends respectively connected to the extension device and the first parachute;
a second parachute; and
a third set of connection lines, each comprising two opposite ends respectively connected to the second parachute and the extension device,
wherein the first parachute fully deployed is reverse umbrella-shaped with respect to the spacecraft.

2. The drogue parachute system according to claim 1, wherein connection lines of the first set of connection lines connected to a central portion of the first parachute are shorter than connection lines of the first set of connection lines connected to a periphery portion of the first parachute.

3. The drogue parachute system according to claim 1, wherein a central portion of the first parachute is thicker than a periphery portion of the first parachute when the first parachute is fully deployed.

4. The drogue parachute system according to claim 1, wherein the second parachute and the third set of connection lines are released from the extension device after the extension device is pushed out from the spacecraft.

5. The drogue parachute system according to claim 4, wherein the second set of connection lines, the first parachute and the first set of connection lines are pulled out from the spacecraft by a drag force of the second parachute after the second parachute is deployed.

6. The drogue parachute system according to claim 5, wherein the second set of connection lines, the extension device, the third set of connection lines and the second parachute are lay idle after the first parachute is fully deployed.

7. The drogue parachute system according to claim 1, wherein the first parachute comprises a first surface and a second surface opposite to the first surface, one of the first and second surfaces is disposed with at least one pressure regulator connected to the at least one inflating device, and the at least one inflating device inflates the first parachute with compressed gas stored in the inflating device, through the at least one pressure regulator.

8. The drogue parachute system according to claim 6, wherein the first parachute comprises at least one gas chamber for being inflated by the compressed gas.

9. The drogue parachute system according to claim 7, wherein an amount of gas chambers in the first parachute is plural, and every two adjacent ones of the gas chambers are connected to each other and have vents on a connection therebetween.

10. The drogue parachute system according to claim 1, wherein the first parachute comprises a first surface and a second surface opposite to the first surface, a part of the first set of connection lines is connected to the first surface in a central portion of the first parachute, another part of the first set of connection lines is connected to the first surface in a periphery portion of the first parachute, and the second set of connection lines is connected to the second surface in the central portion of the first parachute.

11. The drogue parachute system according to claim 1, wherein at least a part of the extension device is flexible.

12. The drogue parachute system according to claim 1, wherein the first, second and third sets of connection lines are made of at least a bulletproof material.

13. The drogue parachute system according to claim 1, wherein the second parachute is smaller than the first parachute.

14. The drogue parachute system according to claim 1, wherein the extension device comprises an inner space for accommodating the second parachute and the third set of connection lines.

15. The drogue parachute system according to claim 1, further comprising a housing for accommodating the first parachute, the first set of connection lines, the second set of connection lines, the extension device, the second parachute and the third set of connection lines.
